(19) United States
(12) Patent Application Publication
(10) Pub. No.: US 2012/0165145 A1
(43) Pub. Date: Jun. 28, 2012

(54) FLAT BELT

(75) Inventors: Yoshiyuki Kitano, Kobe (JP); Masahiro Inukai, Kobe (JP); Mitsuhiko Takahashi, Kobe (JP)

(73) Assignee: BANDO CHEMICAL INDUSTRIES, LTD., Kobe (JP)

(21) Appl. No.: 13/393,481

(22) PCT Filed: Sep. 1, 2009
(86) PCT No.: PCT/JP2009/004295

§ 371 Date: Feb. 29, 2012

(51) Int. Cl. F16G 1/08; B65H 5/02; B65G 15/34

(52) U.S. Cl. 474/264

(57) ABSTRACT

A flat belt includes an adhesive rubber layer formed in an endless ring shape and having a tensile member embedded therein, a first rubber layer provided on a surface of the adhesive rubber layer, and a second rubber layer provided on the other surface of the adhesive rubber layer, in which an elastic modulus in a belt width direction of the adhesive rubber layer is higher than the elastic modulus in the belt width direction of each of the first rubber layer and the second rubber layer.

### TECHNICAL FIELD

The present disclosure relates to flat belts.

### BACKGROUND ART

Conventionally, flats belts are broadly known as belts for conveying paper sheets such as paper currencies in automated teller machines (ATMs) and train tickets in automatic ticket gates and for driving main shafts of machine tools, for example. Being formed thinner than other thick belts such as V-belts, the flat belts suffer a relatively small energy loss caused by bending of the belts. Accordingly, the flat belts have transmission efficiency higher than that of V-belts and the like.

The flat belts generally have a laminated structure as a stack of two or more members, which are made of different materials in many cases. The linear expansion coefficient of the member constituting the flat belts varies depending on its material. Specifically, in a flat belt including members made of different materials, temperature changes caused by heating or cooling cause the members to stretch or contract at different ratios.

Accordingly, in a flat belt having a two-layer structure in which canvas is provided on a surface of a rubber layer, for example, the rubber layer and the canvas have different linear expansion coefficients. Consequently, temperature changes caused by running of the flat belt cause the rubber layer and the canvas to stretch or contract to different extents. This causes the flat belt to suffer warping along a belt width.

There exists a flat belt having a three-layer structure including an adhesive rubber layer, in which a tensile cord as a tensile member is embedded, and inner and outer rubber layers respectively provided on the inner surface and the outer surface of the adhesive rubber layer and made of the same material as that for the adhesive rubber layer. In spite of being made of the same material, if the inner rubber layer provided on the inner surface of the adhesive rubber layer and the outer rubber layer provided on the outer surface of the adhesive rubber layer are different from each other in thickness, the outer and inner rubber layers stretch or contract to different extents due to temperature changes. This causes the flat belt to suffer warping along the belt width.

A process for fabricating a flat belt by vulcanizing and molding an elastomer such as rubber or resin necessarily includes a heating step and a cooling step. Consequently, each member contracts to a different extent due to temperature changes in the fabricating process. This causes the flat belt to suffer warping along the belt width.

When the flat belt warps, it is impossible for the inner rubber layer to come into contact with a pulley substantially in full belt width, and a contact pressure is locally applied by the pulley to the inner rubber layer in the belt width direction. This causes the inner rubber layer to suffer uneven wear on a surface in contact with the pulley, and the surface partially wears out. As a result, the flat belt unstably runs and easily slips to have difficulty in performing a reliable transmission.

To solve this problem, Patent Document 1 describes a flat belt having members made of the same material and having the same thickness. In this flat belt, the members are provided on the inner side and the outer side of the flat belt in a symmetrical manner with respect to the middle of thickness of the flat belt. This structure is intended to balance at both sides in the belt thickness even if each member constituting the flat belt stretches or contracts due to temperature changes caused by running of the belt, and thereby preventing the belt from warping along the belt width.

### CITATION LIST

### Patent Document

PATENT DOCUMENT 1: Japanese Patent Publication No H08-99704

### SUMMARY OF THE INVENTION

### Technical Problem

However, even in the flat belt described in Patent Document 1, warping along the belt width occurs. This is because the symmetric arrangement of the members constituting the flat belt with respect to the middle of the belt thickness is impaired when the thickness of the inner rubber layer decreases due to wear occurring on the surface of the inner rubber layer in contact with the pulley as the flat belt runs. When the flat belt considerably warps, as described above, the flat belt does not come into contact with the pulley substantially in full belt width, and frictional force becomes unstable. Consequently, the flat belt easily slips and snakes, and stable running of the flat belt is impeded.

In addition, if one of the inner and outer rubber layers degenerates due to contact with oil, chemical agents, water and the like, or due to hardening caused by heat generated by slipping and the like, the symmetric arrangement of the members constituting the flat belt with respect to the middle of the belt thickness is impaired, and the flat belt warps along the belt width.

It is therefore an object of the disclosure to reduce the warping along the belt width of the flat belt even when the flat belt suffers wear or degeneration.

### Solution to the Problem

To achieve the object, in the present disclosure, the elastic modulus in the belt width direction of an adhesive rubber layer is higher than the elastic modulus in the belt width direction of each of a first rubber layer and a second rubber layer which sandwich the adhesive rubber layer.

Specifically, a flat belt of the present disclosure includes the adhesive rubber layer formed in an endless ring shape and having a tensile member embedded therein, the first rubber layer provided on a surface of the adhesive rubber layer and the second rubber layer provided on the other surface of the adhesive rubber layer, wherein the elastic modulus in the belt width direction of the adhesive rubber layer is higher than the elastic modulus in the belt width direction of each of the first and second rubber layers.

In the above structure, the elastic modulus in the belt width direction of the adhesive rubber layer is higher than that of each of the first and second rubber layers. When the first and second rubber layers expand or shrink due to temperature changes caused by running of the flat belt, the adhesive rubber layer having a stiffness greater than those of the first and second rubber layers can reduce the warping along the belt width of the flat belt caused by the difference in stretch or contraction between the first and second rubber layers. Accordingly, even when the first and second rubber layers become different from each other in material or thickness due to wear or degeneration which the flat belt suffers, the warping along the belt width of the flat belt can be reduced. As a result, the contact of the flat belt with the pulley substantially in full belt width can be ensured for a long period, and stable running of the flat belt accompanied with reduced slipping and snaking can be achieved.

In a fabricating process of the flat belt having above described structure, the first and second rubber layers contract along the belt width to different extents due to a cooling step performed after a vulcanizing and molding step. The adhesive rubber layer can also reduce the warping along the belt width of the flat belt caused by the above difference in contraction along the belt width between the first and second rubber layers. This effect can reduce the warping along the belt width occurring in the flat belt during the fabricating process and thereby enables fabrication of the flat belt which is even without warping along the belt width.

Preferably, in the flat belt having the above structure, the adhesive rubber layer includes a first adhesive rubber layer which is provided toward the first rubber layer relative to the center of the tensile member, and a second adhesive rubber layer which is provided toward the second rubber layer relative to the center of the tensile member. One of the first adhesive rubber layer and the second adhesive rubber layer is preferably 0.8 times to 1.25 times, both inclusive, as thick as the other.

If the thickness of one of the first adhesive rubber layer and the second adhesive rubber layer was less than 0.8 times that of the other, the difference in stretch or contraction occurring in the first and second adhesive rubber layers due to temperature changes caused by running of the flat belt would become relatively large, and the adhesive rubber layer itself would easily warp along the belt width. If the thickness of one of the first adhesive rubber layer and the second adhesive rubber layer was greater than 1.25 times that of the other, the difference in stretch or contraction occurring in the first and second adhesive rubber layers due to temperature changes would also become relatively large, and the adhesive rubber layer itself would easily warp along the belt width. Accordingly, as described above, when the flat belt has the structure in which one of the first and second adhesive rubber layers is 0.8 times to 1.25 times, both inclusive, as thick as the other, the warping along the belt width of the adhesive rubber layer itself is reduced since the difference in stretch or contraction occurring in the first and second adhesive rubber layers due to temperature changes is reduced.

The first adhesive rubber layer and the second adhesive rubber layer preferably have an identical thickness.

The structure in which the first and second adhesive rubber layers have the identical thickness can reduce the difference in stretch or contraction occurring in the first and second adhesive rubber layers due to temperature changes, in comparison with a case where the first and second adhesive rubber layers have different thicknesses, and thereby can successfully reduce the warping along the belt width of the adhesive rubber layer itself.

Preferably, the adhesive rubber layer includes the first adhesive rubber layer which is provided toward the first rubber layer relative to the center of the tensile member, and the second adhesive rubber layer which is provided toward the second rubber layer relative to the center of the tensile member. The elastic modulus in the belt width direction of one of the first adhesive rubber layer and the second adhesive rubber layer is preferably 0.8 times to 1.25 times, both inclusive, as high as that of the other.

If the elastic modulus in the belt width direction of one of the first adhesive rubber layer and the second adhesive rubber layer was less than 0.8 times that of the other, the difference in stretch or contraction occurring in the first and second adhesive rubber layers due to temperature changes caused by running of the flat belt would become relatively large, and the adhesive rubber layer itself would easily warp along the belt width. If the elastic modulus in the belt width direction of one of the first adhesive rubber layer and the second adhesive rubber layer was higher than 1.25 times that of the other, the difference in stretch or contraction occurring in the first and second adhesive rubber layers due to temperature changes would also become relatively large, and the adhesive rubber layer itself easily warps along the belt width. Accordingly, when the flat belt has the structure in which the elastic modulus in the belt width direction of one of the first and second adhesive rubber layers is 0.8 times to 1.25 times, both inclusive, as high as that of the other, the warping along the belt width of the adhesive rubber layer itself is reduced since the difference in stretch or contraction occurring in the first and second adhesive rubber layers due to temperature changes is reduced.

The first adhesive rubber layer and the second adhesive rubber layer preferably have an identical elastic modulus in the belt width direction.

The structure in which the first and second adhesive rubber layers have the identical elastic modulus in the belt width direction can reduce the difference in stretch or contraction between the first and second adhesive rubber layers, in comparison with a case where the first and second adhesive rubber layers have different elastic moduli in the belt width direction, and thereby can successfully reduce the warping along the belt width of the adhesive rubber layer itself.

The adhesive rubber layer preferably contains short fibers oriented in the belt width direction.

The structure in which the short fibers contained in the adhesive rubber layer are oriented in the belt width direction can effectively enhance the elastic modulus in the belt width direction of the adhesive rubber layer without mixing an excessive amount of the short fibers into the adhesive rubber layer, thereby enabling reduction of degradation of the adhesiveness between the adhesive rubber layer and the first and second rubber layers caused by mixing the short fibers into the adhesive rubber layer.

Furthermore, when the adhesive rubber layer in which the tensile cord as the tensile member is embedded is molded with vulcanization, the adhesive rubber layer is softened by the vulcanization but impervious to considerable change in shape since the adhesive rubber layer contains the short fibers. Accordingly, deformation of the tensile cord such as local unevenness of the embedment depth, which can be caused by the change in shape of the adhesive rubber layer, can be reduced, and the tensile cord can be formed in a desired helical shape.

The difference in elastic modulus in the belt width direction between the adhesive rubber layer and the first rubber layer is preferably equal to or greater than the elastic modulus in the belt width direction of the first rubber layer. The difference in elastic modulus in the belt width direction between the adhesive rubber layer and the second rubber layer is preferably equal to or greater than the elastic modulus in the belt width direction of the second rubber layer.

The structure, in which the difference in elastic modulus in the belt width direction between the adhesive rubber layer and the first rubber layer is equal to or greater than the elastic modulus in the belt width direction of the first rubber layer and the difference in elastic modulus in the belt width direction between the adhesive rubber layer and the second rubber layer is equal to or greater than the elastic modulus in the belt width direction of the second rubber layer, can successfully reduce the warping along the belt width of the flat belt.

The thickness of the adhesive rubber layer preferably constitutes 30% or more of the total thickness of the flat belt.

In the above structure, the adhesive rubber layer, which constitutes 30% or more of the total thickness of the flat belt, is relatively thick for the flat belt as a whole while the first rubber layer and the second rubber layer are relatively thin. Accordingly, even when the first rubber layer and the second rubber layer shrink or expand to different extents due to temperature changes and the like, the stiffness of the adhesive rubber layer, whose elastic modulus is higher than those of the first and second rubber layers and whose thickness is relatively large, can further effectively reduce the warping along the belt width of the flat belt and ensure the contact of the flat belt with the pulley substantially in full belt width.

Preferably, the first rubber layer and the second rubber layer have an identical thickness, are made of an identical material and have an identical elastic modulus in the belt width direction.

The structure in which the first rubber layer and the second rubber layer have the identical thickness, are made of the identical material and have the identical elastic modulus in the belt width direction makes the structure of the flat belt symmetric between the inner and outer sides with respect to the middle of the belt thickness. This structure can balance at both sides in the belt thickness even when the first rubber layer and the second rubber layer stretch or contract to different extents, and the warping along the belt width of the flat belt can be successfully reduced until the flat belt wears out or degenerates.

The tensile member may be made of a tensile cord helically extending along the belt length in a manner such that helical turns of the tensile cord are arranged at predetermined intervals across the belt width.

The above described structure also exerts the effects of the present disclosure in a concrete manner.

### Advantages of the Invention

The present disclosure enables fabrication of the flat belt which is even without warping along the belt width since the elastic modulus in the belt width direction of the adhesive rubber layer is higher than that of each of the first rubber layer and the second rubber layer. The present disclosure can also reduce the warping along the belt width of the flat belt even when the flat belt wears out or degenerates. As a result, the contact of the flat belt with the pulley substantially in full belt width can be ensured for a long period, and stable running of the flat belt accompanied with reduced slipping and snaking can be achieved.

### BRIEF DESCRIPTION OF THE DRAWINGS

FIG. 1 is a perspective cross-sectional view schematically showing a flat belt of a first embodiment.

FIG. 2 is a cross-sectional view schematically showing the structure of a flat belt of the first embodiment

FIG. 3 is a cross-sectional view schematically showing the structure of a flat belt of a comparative example.

FIG. 4 is a graph showing the amounts of warping corresponding to the depths of wear in an example and the comparative example.

### DESCRIPTION OF EMBODIMENTS

Embodiments of the present disclosure will be described in detail with reference to the drawings. It should be noted that the present disclosure is not limited to each embodiment described below.

### First Embodiment

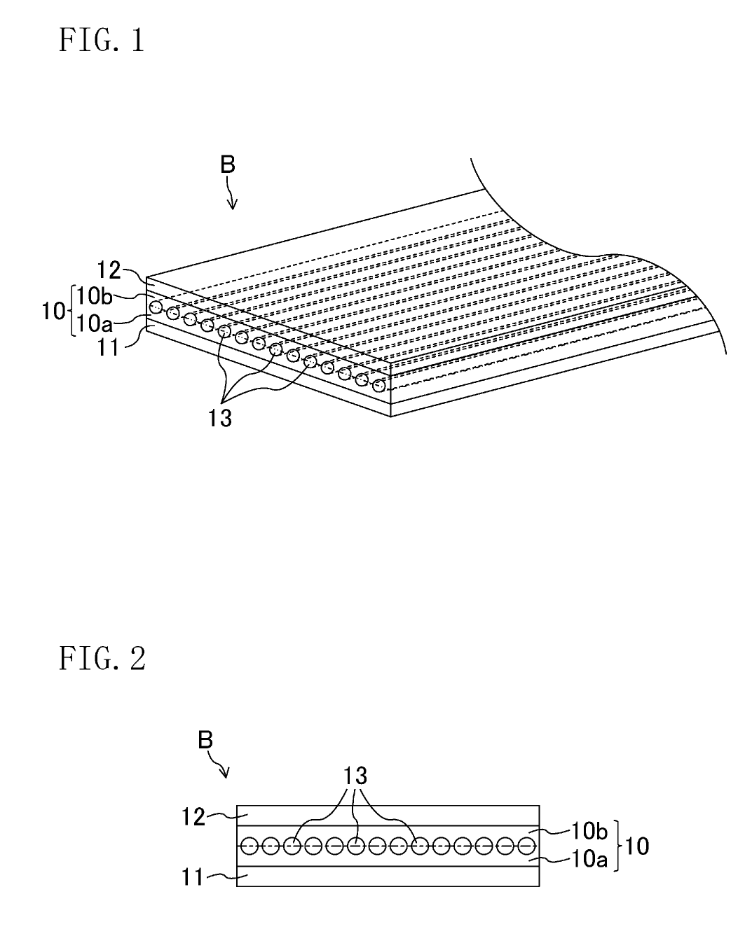

FIGS. 1 and 2 show a first embodiment of a flat belt according to the present disclosure. FIG. 1 is a perspective cross-sectional view schematically showing a flat belt B of the first embodiment. FIG. 2 is a cross-sectional view schematically showing the structure of the flat belt B.

As shown in FIGS. 1 and 2, the flat belt B includes an adhesive rubber layer 10 formed in an endless ring shape, an inner rubber layer 11 provided on the inner surface of the adhesive rubber layer 10 and corresponding to the first rubber layer, and an outer rubber layer 12 provided on the outer surface of the adhesive rubber layer 10 and corresponding to the second rubber layer. The inner rubber layer 11 comes into contact with a pulley, around which the flat belt is allowed to run, at the surface opposite to the adhesive rubber layer 10. The flat belt B is formed, for example, to have a width of about 20 mm and a total thickness of about 2.5 mm.

The inner rubber layer 11 and the outer rubber layer 12 have the same thickness of about 0.6 mm, for example. The inner and outer rubber layers 11 and 12 are made of the same material such as ethylene propylene rubber (hereafter referred to as EPDM). The inner and outer rubber layers 11 and 12 have the same elastic modulus in the belt width direction, which is about 70 MPa, for example. Further, the inner and outer rubber layers 11 and 12 also have the elastic modulus in the belt length direction of about 70 MPa, for example.

A tensile cord 13 as the tensile member is embedded in the adhesive rubber layer 10 which is configured of a tensile-cord inner rubber layer 10a which is provided toward the inner rubber layer 11 relative to the center of the tensile cord 13 and corresponds to the first adhesive rubber layer, and a tensile-cord outer rubber layer 10b which is provided toward the outer rubber layer 12 relative to the center of the tensile cord 13 and corresponds to the second adhesive rubber layer. The thickness of the adhesive rubber layer 10 preferably constitutes 30% or more of the total thickness of the flat belt. The adhesive rubber layer 10 of the present embodiment is formed to have a thickness of, for example, about 1.3 mm which is equivalent to 52% of the total thickness of the flat belt. As described above, since the adhesive rubber layer 10 is sufficiently thick and the inner and outer rubber layers 11 and 12 are relatively thin, even if the inner and outer rubber layers 11 and 12 shrink or expand to different extents due to temperature changes and the like caused by running of the flat belt, the adhesive rubber layer 10 is impervious to affection and deformation caused by such shrinkage or expansion.

The tensile cord 13 helically extends along the belt length in a manner such that helical turns of the tensile cord 13 are arranged at predetermined intervals across the belt width. The tensile cord 13 has a diameter of about 0.5 mm, for example, and is made of a cord-like bundle of organic fibers such as aramid fibers, polyester fibers, polyamide fibers and rayon fibers or inorganic fibers such as glass fibers and steel. The distance between the adjacent turns of the tensile cord 13 arranged across the belt width is set to about 0.85 mm, for example.

The tensile-cord inner rubber layer 10a and the tensile-cord outer rubber layer 10b have the same thickness of about 0.65 mm for example. In other words, the tensile cord 13 is embedded at the middle of the thickness of the adhesive rubber layer 10. The structure in which the tensile-cord inner rubber layer 10a and the tensile-cord outer rubber layer 10b have the same thickness can reduce the difference in stretch or contraction occurring in the tensile-cord inner rubber layer 10a and the tensile-cord outer rubber layer 10b due to temperature changes caused by running of the flat belt, in comparison with a case where the tensile-cord inner rubber layer 10a and the tensile-cord outer rubber layer 10b have different thicknesses.

In a manner similar to the inner rubber layer 11 and the outer rubber layer 12, the tensile-cord inner rubber layer 10a and the tensile-cord outer rubber layer 10b are made of EPDM, for example, and have the same elastic modulus in the belt width direction. The structure in which the tensile-cord inner rubber layer 10a and the tensile-cord outer rubber layer 10b have the same elastic modulus in the belt width direction can reduce the difference in stretch or contraction occurring in the tensile-cord inner rubber layer 10a and the tensile-cord outer rubber layer 10b due to temperature changes caused by running of the flat belt, in comparison with a case where the tensile-cord inner rubber layer 10a and the tensile-cord outer rubber layer 10b have different elastic moduli in the belt width direction.

Further, the elastic modulus in the belt width direction of the adhesive rubber layer 10 (i.e., the tensile-cord inner rubber layer 10a and the tensile-cord outer rubber layer 10b) is higher than the elastic modulus in the belt width direction of each of the inner rubber layer 11 and the outer rubber layer 12. Both of the tensile-cord inner rubber layer 10a and the tensile-cord outer rubber layer 10b constituting the adhesive rubber layer 10 contain short fibers oriented in the belt width direction. Examples of the short fibers include polyamide fibers, polyester fibers, glass fibers, carbon fibers, aramid fibers. Orienting the short fibers in the belt width direction in the adhesive rubber layer 10 effectively enhances the elastic modulus in the belt width direction of the adhesive rubber layer 10 without mixing an excessive amount of the short fibers into the adhesive rubber layer 10, thereby reducing degradation of the adhesiveness between the adhesive rubber layer 10 and the inner and outer rubber layers 11 and 12 which is caused by mixing the short fibers into the adhesive rubber layer 10.

The difference in elastic modulus in the belt width direction between the adhesive rubber layer 10 and the inner rubber layer 11 is preferably equal to or greater than the elastic modulus in the belt width direction of the inner rubber layer 11. The difference in elastic modulus in the belt width direction between the adhesive rubber layer 10 and the outer rubber layer 12 is preferably equal to or greater than the elastic modulus in the belt width direction of the outer rubber layer 12. Thus, the elastic modulus in the belt width direction of the adhesive rubber layer 10 is preferably two or more times as high as the elastic modulus in the belt width direction of each of the inner and outer rubber layers 11 and 12. For example, the elastic modulus in the belt width direction of the adhesive rubber layer 10 is about 400 MPa, which is more than five times as high as the elastic modulus of each of the inner and outer rubber layers 11 and 12. The elastic modulus in the belt length direction of the adhesive rubber layer 10 is about 80 MPa for example. In other words, the tensile-cord inner rubber layer 10a and the tensile-cord outer rubber layer 10b have, for example, the elastic modulus in the belt width direction of about 400 MPa and the elastic modulus in belt length direction of about 80 MPa.

In the flat belt B having the above described structure, since the tensile-cord inner rubber layer 10a and the tensile-cord outer rubber layer 10b are the same in thickness, material and elastic modulus in the belt width direction, these layers 10a and 10b stretch or contract along the belt width to the same extent when temperature changes occur due to running of the flat belt. As a result, the warping along the belt width of the adhesive rubber layer 10 itself is reduced as much as possible.

In the structure in which the elastic modulus in the belt width direction of the adhesive rubber layer 10 is two or more times as high as the elastic modulus of each of the inner and outer rubber layers 11 and 12 and the thickness of the adhesive rubber layer 10 constitutes 30% or more of the total belt thickness, when the inner and outer rubber layers 11 and 12 expand or shrink due to temperature changes caused by running of the flat belt, the stiffness of the adhesive rubber layer 10, which has the elastic modulus higher than those of the inner and outer rubber layers 11 and 12 and the sufficient thickness, successfully reduces the warping along the belt width of the flat belt B caused by the difference in stretch or contraction between the inner and outer rubber layers 11 and 12. Accordingly, the warping along the belt width of the flat belt is reduced even when the inner and outer rubber layers 11 and 12 become different from each other in thickness or material due to the wear or degeneration of the flat belt B. As a result, the contact of the flat belt B with the pulley substantially in full belt width is ensured for a long period, and stable running of the flat belt accompanied with reduced slipping and snaking is achieved.

—Fabricating Method—

A method for fabricating the flat belt B will be described next. First, unvulcanized rubber materials for the inner rubber layer 11 and for the tensile-cord inner rubber layer 10a, the tensile cord 13 and unvulcanized rubber materials for the tensile-cord outer rubber layer 10b and for the outer rubber layer 12 are wrapped in that order around a predetermined mold.

Next, the rubber materials for the inner rubber layer 11, the tensile-cord inner rubber layer 10a, the tensile-cord outer rubber layer 10b and the outer rubber layer 12 are pressurized and heated. In this step, the inner and outer rubber layers 11 and 12 are molded with vulcanization, and the materials for the tensile-cord inner rubber layer 10a and the tensile-cord outer rubber layer 10b are softened and allowed to enter spaces between the adjacent turns of the helical tensile cord 13. Consequently, a belt molding which includes the adhesive rubber layer 10 having the tensile cord 13 embedded therein and formed by molding with vulcanization, is fabricated. In this step, the rubber materials for the tensile-cord inner rubber layer 10a and the tensile-cord outer rubber layer 10b, which include the short fibers oriented in the belt width direction, are impervious to considerable change in shape even when these layers 10a and 10b are softened, and local unevenness of the embedment depth of the tensile member 13 is reduced. Accordingly, the tensile cord 13 is maintained in a desired helical shape evenly in the middle of the adhesive rubber layer 10.

The flat belt B is fabricated by cooling and cutting the belt molding having been removed from the mold into a predetermined width. When the flat belt B is fabricated by molding with vulcanization as described above, the inner and outer rubber layers 11 and 12 contract in the step for cooling the belt molding. The adhesive rubber layer 10 having the stiffness higher than those of the inner and outer rubber layers 11 and 12 can reduce the warping along the belt width of the belt molding caused by the difference in contraction between the inner and outer rubber layers 11 and 12. As a result, the warping of the flat belt B can be reduced in the fabricating process, and the flat belt B which is even and has no warping is fabricated.

### Other Embodiments

In the first embodiment, the tensile-cord inner rubber layer 10a and the tensile-cord outer rubber layer 10b have the same thickness. The present disclosure, however, is not limited to such a structure. The tensile-cord inner rubber layer 10a and the tensile-cord outer rubber layer 10b may have different thicknesses.

If the thickness of one of the tensile-cord inner rubber layer 10a and the tensile-cord outer rubber layer 10b was less than 0.8 times that of the other, the difference in stretch or contraction occurring in the tensile-cord inner and outer rubber layers 10a and 10b due to temperature changes caused by running of the flat belt would become relatively large, and the adhesive rubber layer 10 itself would easily warp along the belt width. If the thickness of one of the tensile-cord inner rubber layer 10a and the tensile-cord outer rubber layer 10b was greater than 1.25 times that of the other, the difference in stretch or contraction occurring in the tensile-cord inner and outer rubber layers 10a and 10b due to temperature changes caused by running of the flat belt would also become relatively large, and the adhesive rubber layer 10 itself would easily warp along the belt width. Accordingly, from the viewpoint that the warping along the belt width of the adhesive rubber layer 10 itself is reduced by reducing the difference in stretch or contraction between the tensile-cord inner and outer rubber layers 10a and 10b, one of these layers 10a and 10b is preferably 0.8 times to 1.25 times, both inclusive, as thick as the other.

In the first embodiment, the tensile-cord inner rubber layer 10a and the tensile-cord outer rubber layer 10b have the same elastic modulus in the belt width direction. The present disclosure, however, is not limited to such a structure. The tensile-cord inner rubber layer 10a and the tensile-cord outer rubber layer 10b may have different elastic moduli in the belt width direction.

If the elastic modulus in the belt width direction of one of the tensile-cord inner rubber layer 10a and the tensile-cord outer rubber layer 10b was less than 0.8 times that of the other, the difference in stretch or contraction between the tensile-cord inner and outer rubber layers 10a and 10b would become relatively large, and the adhesive rubber layer 10 itself would easily warp along the belt width. If the elastic modulus in the belt width direction of one of the tensile-cord inner rubber layer 10a and the tensile-cord outer rubber layer 10b was higher than 1.25 times that of the other, the difference in stretch or contraction between the tensile-cord inner and outer rubber layers 10a and 10b would also become relatively large, and the adhesive rubber layer 10 itself would easily warp along the belt width. Accordingly, from the viewpoint that the warping along the belt width of the adhesive rubber layer 10 itself is reduced by reducing the difference in stretch or contraction between the tensile-cord inner rubber layer 10a and the tensile-cord outer rubber layer 10b, the elastic modulus in the belt width direction of one of these layers 10a and 10b is preferably 0.8 times to 1.25 times, both inclusive, as high as that of the other.

In the first embodiment, the tensile cord 13 as the tensile member is embedded in the adhesive rubber layer 10. The present disclosure, however, is not limited to such a structure. Instead of the tensile cord 13, a tensile member made of a woven fabric of aramid fibers, for example, may be embedded in the adhesive rubber layer.

In the first embodiment, the adhesive rubber layer 10, the inner rubber layer 11 and the outer rubber layer 12 are made of EPDM. The present disclosure, however, is not limited to such a structure. The adhesive rubber layer 10, the inner rubber layer 11 and the outer rubber layer 12 may be made of different materials such as acrylonitrile-butadiene rubber (NBR), butadiene rubber (BR), chloroprene rubber (CR) or a known rubber material. Further, the adhesive rubber layer 10, the inner rubber layer 11 and the outer rubber layer 12 are preferably made of an identical rubber material from the viewpoint that the difference in stretch or contraction occurring in these layers 10, 11 and 12 should be reduced.

In the first embodiment, the adhesive rubber layer 10 contains the short fibers. The present disclosure, however, is not limited to such a structure. The adhesive rubber layer 10 may be devoid of the short fibers. The adhesive rubber layer, for example, may be made of a material having an elastic modulus higher than those of the materials constituting the inner and outer rubber layers in order that the elastic modulus in the belt width direction of the adhesive rubber layer will be higher than those of the inner and outer rubber layers.

In the first embodiment, the difference in elastic modulus in the belt width direction between the adhesive rubber layer 10 and the inner rubber layer 11 is equal to or greater than the elastic modulus in the belt width direction of the inner rubber layer 11, and the difference in elastic modulus in the belt width direction between the adhesive rubber layer 10 and the outer rubber layer 12 is equal to or greater than the elastic modulus in the belt width direction of the outer rubber layer 12. Further, in the first embodiment, the elastic moduli in the belt width direction of the inner and outer rubber layers 11 and 12 are about 70 MPa and the elastic modulus in the belt width direction of the adhesive rubber layer 10 is about 400 MPa. The present disclosure, however, is not limited to such a structure. Each elastic modulus in the belt width direction of the adhesive rubber layer 10, the inner rubber layer 11 and the outer rubber layer 12 may vary from the above described elastic moduli, as long as the elastic modulus in the belt width direction of the adhesive rubber layer 10 is higher than that of each of the inner and outer rubber layers 11 and 12.

In the first embodiment, the inner rubber layer 11 and the outer rubber layer 12 have the same thickness. The present disclosure, however, is not limited to such a structure. The inner and outer rubber layers 11 and 12 may have different thicknesses. Alternatively, the inner rubber layer 11 may be slightly thicker than the outer rubber layer 12, taking into account the wear occurring on the inner rubber layer 11 due to running of the flat belt. This structure balances at both sides in the belt thickness when the inner rubber layer 11 wears out, and the warping along the belt width of the flat belt B can be reduced for a long period.

### Example

An example in which the present disclosure works in a concrete manner will be described next. A running test was conducted on a flat belt B of an example of the present disclosure to measure the amount of warping in relation to the depth of wear on an inner rubber layer 11. The amount of warping indicates how much the inner rubber layer 11 of the flat belt B has deformed compared to its original shape.

The flat belt B of this example has a structure similar to that of the flat belt B of the first embodiment. A tensile cord 13 of the example has a diameter of about 0.5 mm as a whole and is configured of bundled aramid cords each having a diameter of 2400 denier. An adhesive rubber layer 10 contains aramid fibers as the short fibers. In the flat belt B of the example, the inner rubber layer 11, a tensile-cord inner rubber layer 10a, a tensile-cord outer rubber layer 10b and an outer rubber layer 12 are the same as those exemplified in the first embodiment in thickness and in elastic modulus.

As a comparative example, a flat belt having a conventional structure in which its rubber layers have the same elastic modulus was subjected to the same running test as that of the flat belt B of the present example, and the amount of warping in relation to the depth of wear on an inner rubber layer was measured.

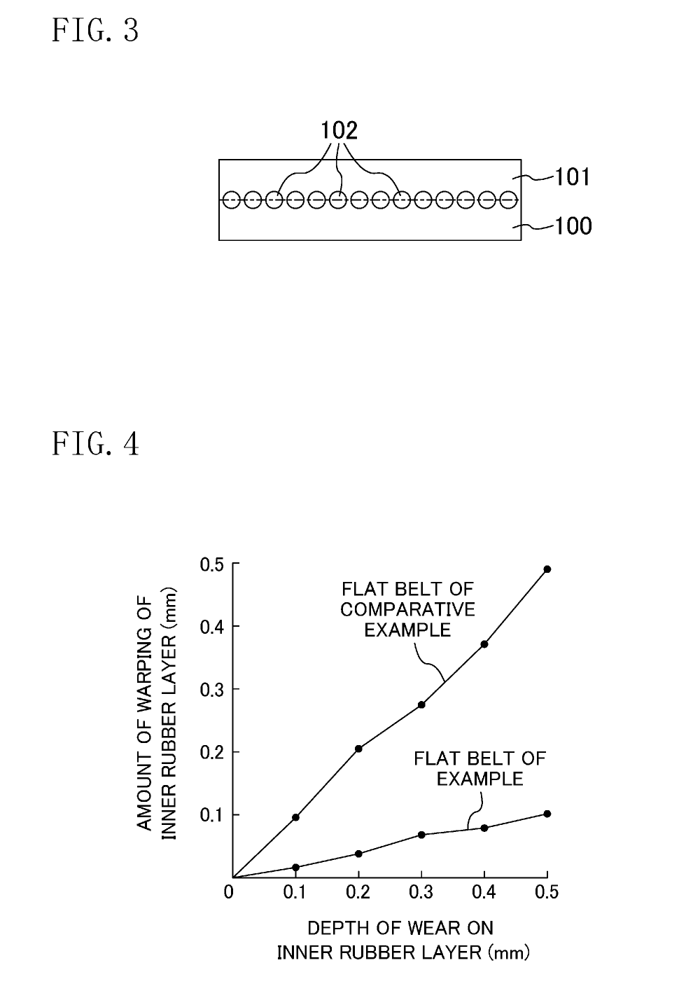

As shown in FIG. 3, the flat belt of the comparative example includes an inner rubber layer 100, an outer rubber layer 101 provided on a surface of the inner rubber layer 100, and a tensile cord 102 embedded as a tensile member between the inner rubber layer 100 and the outer rubber layer 101. In a manner similar to the flat belt B of the example, the flat belt of the comparative example has a belt width of 20 mm and a total belt thickness of 2.5 mm.

The inner rubber layer 100 and the outer rubber layer 101 are made of EPDM and their elastic moduli in the belt width direction and the belt length direction are 70 MPa. The inner and outer rubber layers 100 and 101 are devoid of short fibers. The inner and outer rubber layers 100 and 101 have the same thickness of 1.2 mm. In other words, the tensile cord 102 is embedded in the middle of the thickness of the flat belt. The tensile cord 102 has a structure similar to that of the example and helically extends along the belt length in a manner such that helical turns of the tensile cord 102 are arranged at predetermined intervals across the belt width.

TABLE 1

| | Depth of wear (mm) | | | | | |
|---|---|---|---|---|---|---|
| Amount of warping (mm) | 0 | 0.1 | 0.2 | 0.3 | 0.4 | 0.5 |
| Example | 0 | 0.01 | 0.04 | 0.07 | 0.08 | 0.10 |
| Comparative example | 0 | 0.10 | 0.21 | 0.28 | 0.38 | 0.50 |

The flat belt of the example and the flat belt of the comparative example were each subjected to the running test to measure the depths of wear on the inner rubber layers 11 and 100 and the amounts of warping corresponding to the depths of wear. The results are shown in Table 1 and FIG. 4. Table 1 shows the depths of wear on the inner rubber layers 11 and 100 and the amounts of warping corresponding thereto. FIG. 4 is a graph showing the data in Table 1, i.e., the amounts of warping corresponding to the depths of wear on the inner rubber layers 11 and 100.

As shown in Table 1 and FIG. 4, a relatively large amount of warping was observed on the inner rubber layer 100 as the depth of wear increased due to running of the flat belt. On the other hand, the measurement of the amount of warping of the flat belt B of the example was one-quarter or less of that of the flat belt of the comparative example.

The above test results show that the structure in which the elastic modulus in belt width direction of the adhesive rubber layer 10 is higher than those of the inner and outer rubber layers 11 and 12 reduces the warping along the belt width of the flat belt B even if the flat belt B wears out due to running of the flat belt B.

### INDUSTRIAL APPLICABILITY

As described above, the present disclosure is useful for flat belts. In particular, the present disclosure is suitable for a flat belt whose warping along the belt width needs to be reduced even if the flat belt suffers wear and degeneration.

### DESCRIPTION OF REFERENCE CHARACTERS

(B) Flat belt
(10) Adhesive rubber layer
(10a) Tensile-cord inner rubber layer (First adhesive rubber layer)
(10b) Tensile-cord outer rubber layer (Second adhesive rubber layer)
(11) Inner rubber layer (First rubber layer)
(12) Outer rubber layer (Second rubber layer)
(13) Tensile cord (Tensile member)

1. A flat belt, comprising:
an adhesive rubber layer formed in an endless ring shape and having a tensile member embedded therein;
a first rubber layer provided on a surface of the adhesive rubber layer; and
a second rubber layer provided on the other surface of the adhesive rubber layer;
wherein
an elastic modulus in a belt width direction of the adhesive rubber layer is higher than an elastic modulus in the belt width direction of each of the first rubber layer and the second rubber layer.

2. The flat belt of claim 1, wherein
the adhesive rubber layer includes a first adhesive rubber layer which is provided toward the first rubber layer relative to a center of the tensile member and a second adhesive rubber layer which is provided toward the second rubber layer relative to the center of the tensile member, and
one of the first adhesive rubber layer and the second adhesive rubber layer is 0.8 times to 1.25 times, both inclusive, as thick as the other.

3. The flat belt of claim 2, wherein
the first adhesive rubber layer and the second adhesive rubber layer have an identical thickness.

4. The flat belt of claim 1, wherein
the adhesive rubber layer includes the first adhesive rubber layer which is provided toward the first rubber layer relative to a center of the tensile member and the second adhesive rubber layer which is provided toward the second rubber layer relative to the center of the tensile member, and
an elastic modulus in the belt width direction of one of the first adhesive rubber layer and the second adhesive rubber layer is 0.8 times to 1.25 times, both inclusive, as high as that of the other.

5. The flat belt of claim 4, wherein
the first adhesive rubber layer and the second adhesive rubber layer have an identical elastic modulus in the belt width direction.

6. The flat belt of claim 1, wherein
the adhesive rubber layer contains short fibers oriented in the belt width direction.

7. The flat belt of claim 1, wherein
a difference in elastic modulus in the belt width direction between the adhesive rubber layer and the first rubber layer is equal to or greater than the elastic modulus in the belt width direction of the first rubber layer, and
a difference in elastic modulus in the belt width direction between the adhesive rubber layer and the second rubber layer is equal to or greater than the elastic modulus in the belt width direction of the second rubber layer.

8. The flat belt of claim 1, wherein
a thickness of the adhesive rubber layer constitutes 30% or more of a total thickness of the flat belt.

9. The flat belt of claim 1, wherein
the first rubber layer and the second rubber layer have an identical thickness, are made of an identical material and have an identical elastic modulus in the belt width direction.

10. The flat belt of claim 1, wherein
the tensile member is made of a tensile cord helically extending along a belt length in a manner such that helical turns of the tensile cord are arranged at predetermined intervals across the belt width.
